(19) United States
(12) Patent Application Publication
(10) Pub. No.: US 2003/0053378 A1
(43) Pub. Date: Mar. 20, 2003

(54) Wireless digital audio to AM/FM decoder and modulator

(75) Inventors: James Milton Lovin, Melbourne, FL (US); William Robert Lovin, Melbourne, FL (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Radielle, Inc., Melbourne, FL

(21) Appl. No.: 10/210,856

(22) Filed: Jul. 31, 2002

Related U.S. Application Data
(63) Continuation-in-part of application No. 10/193,724, filed on Jul. 10, 2002.
(60) Provisional application No. 60/309,015, filed on Jul. 31, 2001.
(60) Provisional application No. 60/304,945, filed on Jul. 11, 2001.

(51) Int. Cl. H04H 9/00; G06F 17/00

(52) U.S. Cl. 369/7; 700/94

(57) ABSTRACT

A wireless digital audio to AM/FM decoder and modulator capable of communicating with a radio receiver includes a short-range wireless networking transceiver using a standardized digital communications protocol to receive digital data representing audible information. A controller converts the digital data into intermediate format digital data that may be stored in a memory device. A digital to analog converter converts the intermediate format digital data into an audio frequency signal, which is transmitted by a radio frequency transmitter at very low power to the radio receiver. In an alternative embodiment, the controller converts the digital data representing audible information into a digital representation of a radio frequency signal modulated with the audible information. A radio frequency amplifier transmits the radio frequency signal at very low power to the radio receiver. In one application, the AM/FM decoder and modulator may be connected directly or wirelessly to an automobile radio antenna.

### RELATED APPLICATION(S)

This application claims the benefit of U.S. Provisional Application No. 60/309,015, filed on Jul. 31, 2001 and is a Continuation-in-Part of U.S. Application No. 10/193,724, filed Jul. 10, 2002, which claims priority to U.S. Provisional Application No. 60/304,945, filed Jul. 11, 2001. The entire teachings of the above applications are incorporated herein by reference.

### FIELD OF THE INVENTION

The present invention relates to wireless communications equipment, more particularly radio communications equipment incorporating wireless local area networking devices.

### BACKGROUND OF THE INVENTION

The recent ascension of Bluetooth(TM), HomeRF(TM), 802.11, and similar wireless local area networking (LAN) standards has engendered an entirely new class of wireless devices with new abilities to communicate among themselves.

The wireless LAN technology can be used, for example, to take advantage of new media formats in ways that individual devices or systems cannot by themselves. For example, there are complete systems that are capable of receiving digitally encoded audio information via a wired network connection, decoding the encoded audio information, and wirelessly transmitting the resulting audible information to an FM radio. These are not unitary devices, but rather systems composed of a personal computer, with a wired connection to a network such as the Internet, and a separate device such as the SonicBox(TM) from SonicBox, Inc. or the Kima KS-100 from Akoo.com, Inc.

In these systems, the personal computer receives digitally encoded audio information via a wired connection from the Internet and decodes and converts it into audible signals by means of a software coder/decoder (codec) program running on the personal computer and a sound card installed within the personal computer. Both the SonicBox(TM) and the Kima KS-100 attach to the audio output(s) of the sound card and transmit the audio output signal(s) via a 900 MHZ analog FM wireless link to a matching receiver that then converts the 900 MHZ analog FM signal to an FM signal in the FM broadcast band. The FM broadcast band signal is then transmitted to one or more nearby FM radio receivers. Systems such as these have three notable shortcomings:

1) they require two pieces of hardware to perform the necessary decoding, conversion, and transmission —a personal computer and a transmission system;

2) they receive digitally encoded audible information via a physical wired connection to the Internet or a similar computer network. This obviously limits the ability of these systems to be used in a mobile situation; and,

3) the transmission system noted above transports audible data from the personal computer to the FM radio receiver via an intervening 900 MHZ wireless analog link. Ultimately, this results in poorer audible quality when the audio data is reproduced.

### SUMMARY OF THE INVENTION

What is needed is a device that is capable of receiving such wirelessly transmitted digitally encoded audible information, decoding it to audible signals, modulating the resulting audible signals onto an AM or FM carrier to form an AM or FM radio signal, and subsequently transmitting the resulting AM or FM radio signals via a low-power transmitter to a nearby, or attached, AM/FM radio.

An example application for wireless local area network devices that is not supported by existing systems is one that allows low-cost portable devices to take advantage of more expensive non-portable systems. For example, a handheld MP3 player equipped with headphones is very useful in terms of listening to music while exercising, but is inadequate for listening to music while driving an automobile due to background noise and laws discouraging driving while wearing headphones. So, an MP3 player or other personal electronic device that could transmit audio signals to an automobile stereo would allow a user to have on-demand access to her favorite songs and to listen to those songs via the automobile's stereo.

The teachings of the present invention supports such an application. In one particular embodiment, a device employing those principles includes a wireless digital audio-to-AM/FM modulator that:

1. receives digital media representing digitally encoded audio information in a digital encoding format including, without limitation, pulse code modulation (PCM), Real Audio(TM), Dolby® AAC, Microsoft® WMA, and streaming MP3 , via a Bluetooth(TM), HomeRF(TM), 802.11, or any other wireless or wired local area networking link;

2a. decodes the digital media into an audible representation of the media and modulates the audible representation of the media onto an AM or FM carrier, thus forming an analog AM or FM radio signal, which is then transmitted via a low-power radio transmitter to a nearby, or attached, AM or FM radio receiver; or

2b. decodes said digital media from its native digital form directly into a digitized representation of an AM or FM radio signal modulated with an audible representation of the media, converts said digitized representation of an AM or FM radio signal modulated with an audible representation of the media into an analog AM or FM radio signal by means of a digital to analog converter, and then transmits said analog AM or FM radio signal via a low-power radio frequency amplifier to a nearby, or attached, AM or FM radio receiver.

In an alternative embodiment, the teachings of the present invention:

1. provide a means whereby wirelessly transmitted digitally encoded audio information is decoded from any one of a multiplicity of standard digital encoding formats and converted to an analog AM or FM radio signal;

2) provide a means whereby wirelessly transmitted digitally encoded audio information may be reproduced through a conventional AM or FM radio; and,

3) provide such decoding and such transmitting means through a single, unitary device installable in an automobile or other conveyance and operable with a conventional AM or FM radio also installed in the automobile or other conveyance.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a diagram illustrating an example application of a system employing an embodiment of the present invention;

FIG. 2 is a block diagram of example hardware components used in the system of FIG. 1 in which the system is configured to receive digitized audible information via an 802.11 wireless local area network;

FIG. 3 is a diagram illustrating an alternative implementation of the system of FIG. 1; and FIG. 4 is a block diagram of example hardware components used in the system of FIG. 3 in which the system is configured to receive digitized audible information via a Bluetooth(TM) wireless local area network.

### DETAILED DESCRIPTION OF THE INVENTION

A description of preferred embodiments of the invention follows.

In a first preferred embodiment, a device employing the principles of the present invention receives digital information representing speech, music, or other audible information in streaming MP3 format via an 802.11 wireless local area network. In this embodiment, the device is constructed with coaxial connectors so that the device may be installed in the automotive radio antenna lead physically between the vehicle's AM/FM radio receiver and its automotive radio antenna. When broadcasting, the device utilizes a low power FM transmitter to transmit audible information on a user-designated FM frequency via that portion of the automotive radio antenna lead attached to the vehicle's AM/FM radio receiver while simultaneously allowing all other AM/FM frequencies to be received by the radio as usual.

The AM/FM radio receiver audibly reproduces the transmission as the device broadcasts it. The AM/FM radio receiver outputs the resulting audio through the speaker(s) attached to the radio. Thus, high quality sound output is possible in the vehicle using an inexpensive portable device to transport the digital information.

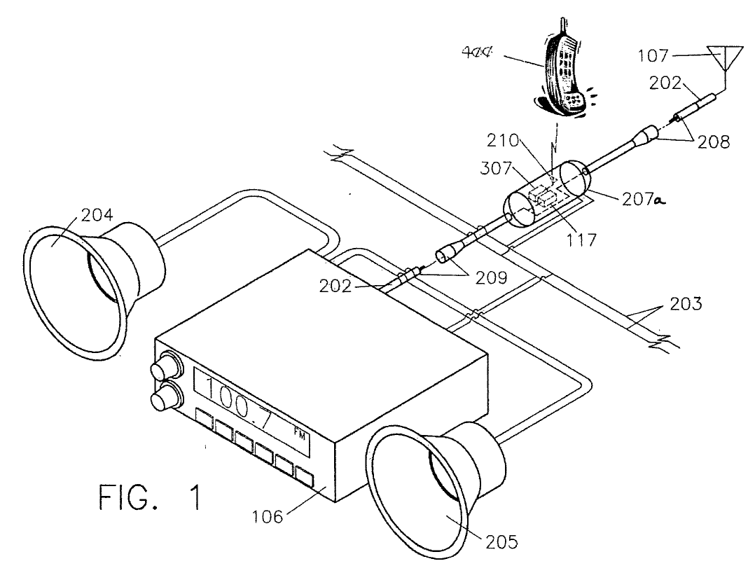

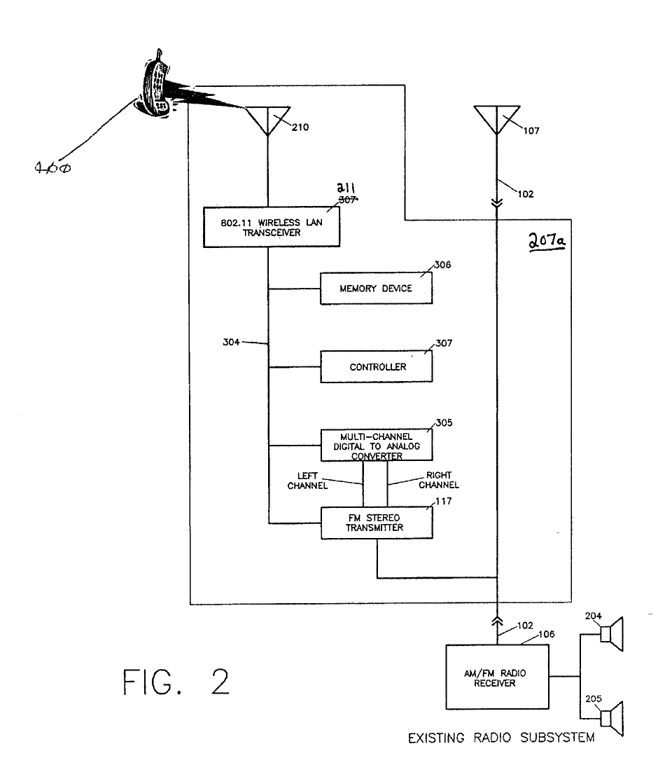

FIG. 1 shows a diagram illustrating the first preferred embodiment of the present invention, just described. The device 207a is physically installed in an automotive radio antenna lead 202 between AM/FM radio receiver 106 and its automotive radio antenna 107. The device 207a is electrically connected to the automotive radio antenna lead 202 using standard coaxial cable connectors 208-209. Electrical power is supplied to the device 207a from the automobile's power distribution system 203.

The device 207a incorporates a first wireless connection via a short-range wireless network equipment (e.g., wireless personal area network or wireless local area network equipment), such as an 802.11 wireless local area networking antenna 210 and transceiver 307 for the reception of 802.11 wireless local area networking radio waves. The device 207a also includes a second wireless connection that may include a separate FM stereo transmitter 117 to provide FM radio waves transmitted for reception by the vehicle's existing AM/FM radio receiver 106 via that portion of the automotive radio antenna lead 202 attached to the vehicle's AM/FM radio receiver. Electrical power is supplied to AM/FM radio receiver 106 via the automobile's power distribution system 203. The radio receiver 106 is connected to one or more speakers 204-205.

An example of a personal communications device 400, such as a cellular telephone equipped with both long-range cellular or digital telecommunications capability and short-range wireless (e.g., radio frequency or infrared) capability, is wirelessly connected to the device 207a via a short-range wireless communications protocol. Examples of short-range wireless communications protocols include 802.11 or Bluetooth™.

An example of a transmission sent from the personal communications device 400 to the AM/FM radio receiver 106 via the device 206a is music. The personal communications device 400 may download the music from a file server via a wireless cellular or digital telephone network in the form of an MPEG™ music file using a standard cellular or digital TDMA, CDMA or GSM wireless communications protocol, store the music file in memory, and then output the music file to the AM/FM radio receiver 106 via the device 207a through use of the Bluetooth™ wireless protocol.

FIG. 2 is a block diagram showing example hardware elements contained in the device 207a. The device 207a includes an 802.11 wireless local area networking antenna 210 and 802.11 wireless local area networking transceiver 211, which receive 802.11 wireless local area networking radio waves representing digitally encoded audible information from, for example, the personal communications device 400. The 802.11 wireless local area networking transceiver 211 emits a digital data stream onto digital data bus 304, where the data stream may include (i) network control and protocol data and (ii) digitally encoded audio data in MP3 format. A controller 307 extracts the digitally encoded audio data from the digital data stream and stores it in memory device 306.

An MP3 coder/decoder (codec) program previously loaded from memory device 306 and executing on the controller 307 subsequently (i) begins retrieving the digitally encoded audio data from the memory device 306 on a first-in first-out basis, (ii) decodes it from its native MP3 digital format into two intermediate format digital data streams, one representing the left stereo channel and the other representing the right stereo channel, and (iii) sends the two intermediate format digital data streams via a digital data bus 304 to a multi-channel digital-to-analog converter 305. The stereo audio outputs from multi-channel digital-to-analog converter 305 are then applied to the audio inputs of the FM stereo transmitter 117, which then supplies an FM stereo radio signal on a preset FM broadcast frequency to that portion of the automotive radio antenna lead 102 attached to the vehicle's AM/FM radio receiver 106.

The broadcast is subsequently received by the vehicle's existing AM/FM radio receiver 106 and is then audibly reproduced by the existing AM/FM radio receiver 106 via one or more attached speakers 204-205. The device 207a is designed to permit all AM/FM radio waves received via the automotive radio antenna 107 to pass through the device to the AM/FM radio receiver 106. The device 207a may interrupt this flow when it is broadcasting, preferably on the preset FM broadcast frequency on which it is broadcasting.

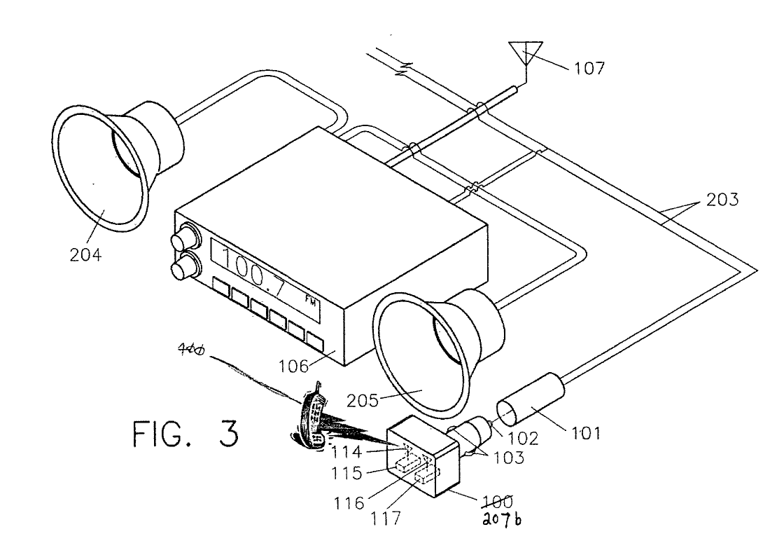

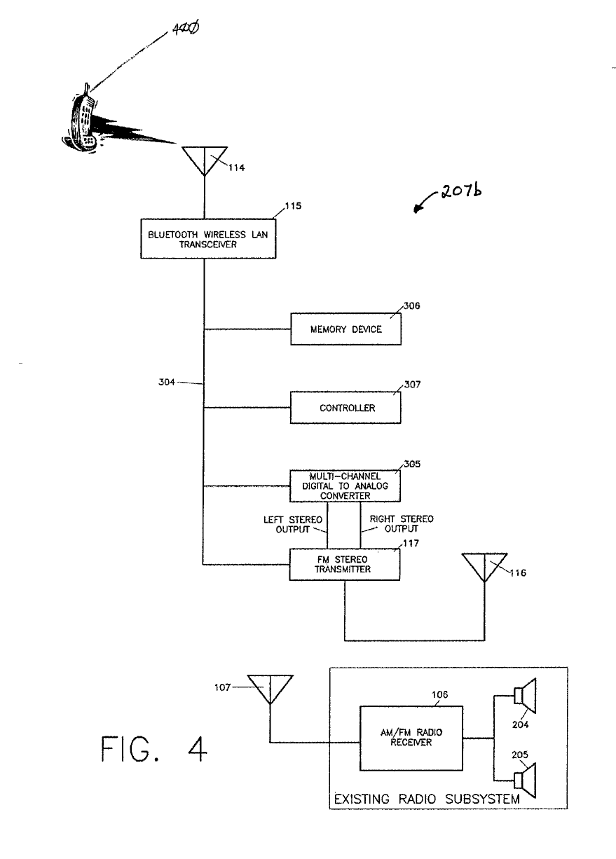

FIG. 3 is a diagram illustrating an example use of the second preferred embodiment of the present invention. In its second preferred embodiment, the device 207b receives digital information representing speech, music, or other audible information in streaming MP3 format via a Bluetooth(TM) wireless local area network from, for example, the personal communications device 400. In this embodiment, the device 207b is constructed to operate while plugged into a conventional cigarette lighter, or similar receptacle, within the user's vehicle. When broadcasting, the device 207b utilizes a low-power FM transmitter to transmit audible information decoded from the received digital information to a nearby FM radio receiver on a user-designated FM frequency.

The AM/FM radio receiver audibly reproduces the transmission as the device 207b broadcasts it. The AM/FM radio receiver 106 outputs the resulting audio through the speaker(s) 204, 205 attached to the radio receiver 106. Ease of installation and portability by the user from vehicle to vehicle are facilitated through this embodiment Continuing to refer to FIG. 3, the device 207b is plugged into an available cigarette lighter receptacle 101 located in the vehicle. The device 207b receives DC power from the automobile's power distribution system 203 through the cigarette lighter receptacle 101 via contacts 102-103 installed in the mating part of the device 207b. The device 207b incorporates (i) a Bluetooth(TM) wireless local area networking antenna 114 and transceiver 115 for the reception of Bluetooth(TM) local area networking radio waves, (ii) separate FM transmission antenna 116, and (iii) FM stereo transmitter 117, whereby FM radio waves are transmitted for reception by the vehicle's existing AM/FM radio receiver 106 via the receiver's automotive radio antenna 107. Electrical power is supplied to AM/FM radio receiver 106 via the automobile's power distribution system 203. The AM/FM radio receiver 106 is connected to one or more speakers 204-205.

FIG. 4 is a block diagram showing example hardware elements contained in the second preferred embodiment of the device 207b. Bluetooth(TM) wireless local area networking radio waves representing digitally encoded audible information are received by the Bluetooth(TM) wireless local area networking antenna 114 and transceiver 115. The Bluetooth(TM) wireless local area networking transceiver 115 emits (i) a digital data stream including network control and protocol data and (ii) digitally encoded audio data in MP3 format onto digital data bus 304.

The controller 307 extracts the digitally encoded audio data from the digital data stream and stores it in the memory device 306. The MP3 coder/decoder (codec) program previously loaded from the memory device 306 and presently executing on the controller 307 subsequently begins retrieving the digitally encoded audio data from the memory device 306 on a first-in first-out basis. The program then decodes the encoded audio data from its native MP3 digital format into two intermediate format digital data streams, one representing the left stereo channel and the other representing the right stereo channel, and sends them via digital data bus 304 to multi-channel digital-to-analog converter 305. The stereo audio outputs from the multi-channel digital-to-analog converter 305 are then applied to the audio inputs of the FM stereo transmitter 117, which subsequently supplies a FM stereo radio signal to the FM transmission antenna 116. The broadcast is subsequently received by the vehicle's existing AM/FM radio receiver 106 via the receiver's automotive radio antenna 107. The broadcast is then audibly reproduced by the existing radio receiver via one or more attached speakers 204-205.

The digitally encoded audio data referenced in both preferred embodiments discussed above may be received in, and converted from, one or more audio data encoding formats, including without limitation, pulse code modulation (PCM), Dolby® AAC, MP3 , Microsoft® WMA, Real Audio(TM), and Sony® ATRAC. In both preferred embodiments, a multiplicity of coder/decoder (codec) software programs may be included with the device 207a, 207b, or loaded subsequently via the integral wireless local area networking transceiver and a loader program included with the device 207a , 207b.

In other embodiments, the short-range wireless networking transceiver receives multiple streams of digital data representing audible information. The device includes hardware sufficient for processing, converting, storing, and transmitting the multiple streams of digital data in a manner set forth above.

In other embodiments, the outputs of the multi-channel digital-to-analog converter 305 may be amplified and supplied directly to the audio inputs of a suitably equipped radio receiver, television receiver, portable stereo, or audio amplifier, thus eliminating a need for an FM stereo transmitter.

In other embodiments, the device 207a, 207b may be constructed entirely or partially within another device, including without limitation, a radio receiver, television receiver, portable stereo, or audio amplifier.

In other embodiments, the memory device 306 may be implemented as any type of non-volatile memory device in any form factor including, without limitation: PC Card, CompactFlash(TM), SmartMedia(TM), or Sony® MemoryStick(TM).

In other embodiments, the memory device 306 may be physically broken into two non-volatile memory devices: one permanently mounted inside the device 207a, 207b and the other removable. In these embodiments, the software coder/decoder (codec) programs might reside in the permanently mounted non-volatile memory device while received digitally encoded audio data might reside in the removable non-volatile memory device.

In other embodiments, the Bluetooth(TM) and 802.11 wireless local area network transceivers 307 may be replaced by any other type of short-range wireless network transceiver including, without limitation: a HomeRF(TM) local area network transceiver; circuit switched cellular data transceiver of any type supporting GSM, CDMA, or IS-135 wireless networks; packet switched cellular data transceiver of any type supporting GPRS, EDGE, WCDMA, CDMA 2000 1x, or CDMA 2000 1xEV wireless networks; personal area network transceiver; or any other kind of wireless data network transceiver.

In other embodiments, the Bluetooth(TM) and 802.11 wireless local area network transceivers 307 may be augmented or supplemented by any other type of wireless network transceiver including, without limitation: a HomeRF(TM) local area network transceiver; circuit switched cellular data transceiver of any type supporting GSM, CDMA, or IS-135 wireless networks; packet switched cellular data transceiver of any type supporting GPRS, EDGE, WCDMA, CDMA 2000 1x, or CDMA 2000 1xEV wireless networks; personal area network transceiver; or any other kind of wireless data network transceiver.

While the invention has been described in connection with what are considered to be the most practical and preferred embodiments, it is to be understood that the invention is not to be limited to the disclosed embodiments, but on the contrary is intended to cover various modifications and equivalent arrangements included within the spirit and scope of the appended claims. Nor is the invention limited to the physical embodiments described herein.

Rather, the invention may be installed partially or entirely within a radio receiver, television receiver, portable stereo, or audio amplifier; broken into constituent pieces, the sum of which constitute the invention in toto, some of which may be installed physically within another device and some installed without but interconnected via wired or wireless means, or, rendered completely into any other shape or form.

What is claimed is:

1. A wireless digital audio to AM/FM decoder and modulator capable of communicating with a radio receiver, comprising:
a short-range wireless networking transceiver using a standardized digital communications protocol to receive at least one stream of digital data representing audible information;
a controller coupled to the transceiver to process the received said at least one stream of digital data;
a software program operating on said controller to convert said at least one stream of digital data representing audible information into at least one stream of intermediate format digital data;
a memory device coupled to said controller to store said at least one stream of digital data representing audible information and said software program;
a digital-to-analog converter having at least one channel coupled to said controller to convert said at least one stream of intermediate format digital data into a like number of audio frequency signals; and
a radio frequency transmitter coupled to said digital-to-analog converter to transmit said audio frequency signals at very low power to said radio receiver.

2. A wireless digital audio to AM/FM decoder and modulator according to claim 1 wherein said short-range wireless networking transceiver complies with at least one of the following standards: the Bluetooth wireless local area networking standard, HomeRF wireless local area networking standard, personal area networking standard, or IEEE wireless local area networking standard.

3. A wireless digital audio to AM/FM decoder and modulator according to claim 1 wherein said digital data representing audible information includes at least one of the following formats: pulse code modulation format, MPEG-2 Audio Layer 3 digital format, MPEG-2 AAC digital format, Real Audio digital format, ATRAC digital format, or the WMA digital format.

4. A wireless digital audio to AM/FM decoder and modulator capable of communicating with a radio receiver, comprising:
a short-range wireless networking transceiver using a standardized digital communications protocol to receive at least one stream of digital data representing audible information;
a controller coupled to the transceiver to process the received said at least one stream of digital data;
a software program operating on said controller to convert said at least one stream of digital data representing audible information into at least one stream of digital representations of radio frequency signals modulated with said audible information;
a memory device coupled to said controller to store said at least one stream of digital data representing audible information and said software program;
a digital-to-analog converter having at least one channel coupled to said controller to convert said at least one stream of digital representations of radio frequency signals into a like number of radio frequency signals; and
a radio frequency amplifier coupled to said multi-channel digital-to-analog converter to transmit said radio frequency signals at very low power to a radio receiver.

5. A wireless digital audio to AM/FM decoder and modulator according to claim 4 wherein said short-range wireless networking transceiver complies with at least one of the following standards: the Bluetooth wireless local area networking standard, HomeRF wireless local area networking standard, personal area networking standard, or IEEE wireless local area networking standard.

6. A wireless digital audio to AM/FM decoder and modulator according to claim 4 wherein said digital data representing audible information includes at least one of the following formats: pulse code modulation format, MPEG-2 Audio Layer 3 digital format, MPEG-2 AAC digital format, Real Audio digital format, ATRAC digital format, or the WMA digital format.
